(19) United States
(12) Patent Application Publication
(10) Pub. No.: US 2026/0231015 A1
(43) Pub. Date: Aug. 6, 2026

(54) METHOD, USER EQUIPMENT AND ACCESS NETWORK NODE

(71) Applicant: NEC Corporation, Tokyo (JP)

(72) Inventors: Maxime GRAU, Guildford (GB); Ayesha lJAZ, Guildford (GB); Pravjyot DEOGUN, Milton Keynes (GB)

(73) Assignee: NEC Corporation, Tokyo (JP)

(21) Appl. No.: 19/154,807

(22) PCT Filed: Feb. 6, 2024
(86) PCT No.: PCT/JP2024/003872

§ 371 Date: Aug. 8, 2025

(30) Foreign Application Priority Data
Feb. 16, 2023 (GB) 2302235.3

(51) Int. Cl. H04W 52/02; H04L 5/00; H04W 24/10; H04W 74/0833

(52) U.S. Cl. CPC H04W 52/0203; H04L 5/0053; H04W 24/10; H04W 74/0833

(57) ABSTRACT

The present disclosure relates to, amongst other things, a method for a user equipment, UE, in a telecommunication system comprising a first access network node operating a first cell and at least one second access network node operating at least one network energy saving, NES, cell, the method comprising: receiving, from the first access network node, information relating to measurement opportunities for the at least one NES cell; and measuring signals transmitted by the at least one NES cell based on the received information.

### TECHNICAL FIELD

The present disclosure relates to a communication system.

### BACKGROUND ART

The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive, relevance to assisting devices to measure cells operating in a network energy saving (NES) state, and how to transition those cells from a NES state to a normal operating state.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

Under the 3GPP standards, a NodeB (or an eNB in LTE, gNB in 5G) is the radio access network (RAN) node (or simply ‘access node’, ‘access network node’ or ‘base station’) via which communication devices (sometimes referred to as user equipment (‘UE’), mobile terminals, or the like) connect to a core network and communicate with other communication devices or remote servers. For simplicity, the present application will use the term RAN node or base station to refer to any such access nodes.

### SUMMARY OF INVENTION

### Technical Problem

There is a need for improved wireless communication networks having improved energy efficiency (sometimes referred to as using Network Energy Saving, NES, techniques). A reduction in the amount of energy needed to operate a communication network beneficially reduces the environmental impact of operating the system, and also reduces the operational costs. For example, the energy consumption of base stations and other similar access network nodes represents a major operational expenditure for network operators, in addition to presenting concerns with respect to the environmental impacts of operating telecommunications networks. There are various tools to save energy at the network side. For example, one method of achieving a more efficient communication network is to regulate the energy requirements of the radio access network part of the system. It will be appreciated that the energy consumption of the radio access network includes a dynamic part that is associated with data transmission and reception, and a static part that associated with operations of the radio access devices that are performed even when there is no ongoing data transmission or reception. The static part may include, for example, the power required to operate a user equipment (UE) in a mode in which the UE is able to receive and decode a physical downlink control channel (PDCCH) transmitted by a base station. Energy saving modes may be configured for one or more devices in the system (e.g. a base station and/or a UE). For example, a base station may be configured to operate in an energy saving state/mode (which may also be referred to as a “dormant” or “inactive” state/mode) in which the base station performs a reduced number of transmissions, or in which the base station is configured not to attempt to transmit or receive signals during a particular time period.

Cells whose transmission/reception characteristics can be modified in this way may be called “NES cells” or “capacity cells”. For example, capacity cells (i.e. cells that are deployed for assisting certain areas in peak times) can be switched off and neighbouring cells are aware of whether the capacity cell is available or not. Accordingly, this function allows, for example in a deployment where capacity boosters can be distinguished from cells providing basic coverage, to optimise energy consumption enabling the possibility for an E-UTRA cell or an E-UTRA—New Radio Dual Connectivity (EN-DC) cell providing additional capacity via single or dual connectivity, to be switched off when its capacity is no longer needed and to be re-activated on a need basis. The decision is typically based on cell load information, and the switch-off decision may also be taken by an Operations and Maintenance (O&M) node, or another suitable core network node.

However, when implementing energy saving methods in a radio access network there are a number of considerations that need to be taken into account. For example, the impact on the performance of the network (e.g. with respect to latency) of the network energy saving methods is important to consider. Efficient configuration of the activation and deactivation (e.g. wake-up) of energy saving modes that ensures that devices are still able to communicate reliably and with acceptable latency are needed. More generally, there is a need for more efficient and reliable methods and apparatus for increasing the energy efficiency of wireless communication systems.

### Solution to Problem

The disclosure aims to provide apparatus and methods that at least partially address the above needs and/or issues.

In one aspect the disclosure provides method for a user equipment, UE, in a telecommunication system comprising a first access network node operating a first cell and at least one second access network node operating at least one network energy saving, NES, cell, the method comprising: receiving, from the first access network node, information relating to measurement opportunities for the at least one NES cell; and measuring signals transmitted by the at least one NES cell based on the received information.

The information may comprise location information in respect of the at least one NES cell and wherein the UE may decide whether or not to trigger a measurement of the at least one NES cell using the location information.

The UE may decide whether or not to trigger a measurement of the at least one NES cell using the location information and location information for the UE.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a method for an access network node operating a first cell in a telecommunication system, the telecommunication system further comprising a user equipment, UE, and at least one second access network node operating at least one network energy saving, NES, cell, the method comprising: transmitting, to the UE, a message comprising information relating to measurement opportunities for the at least one NES cell, to allow the UE to measure signals transmitted by the at least one second cell.

The information may comprise location information in respect of the at least one NES cell to allow the UE to decide whether or not to trigger a measurement of the at least one NES cell using the location information.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a user equipment, UE, in a telecommunication system comprising a first access network node operating a first cell and at least one second access network node operating at least one network energy saving, NES, cell, the UE comprising: means for receiving, from the first access network node, information relating to measurement opportunities for the at least one NES cell; and means for measuring signals transmitted by the at least one NES cell based on the received information.

The information may comprise location information in respect of the at least one NES cell and wherein the UE may be configured to decide whether or not to trigger a measurement of the at least one NES cell using the location information.

The UE may be configured to decide whether or not to trigger a measurement of the at least one NES cell using the location information and location information for the UE.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides an access network node configured to operate a first cell in a telecommunication system, the telecommunication system further comprising a user equipment, UE, and at least one second access network node operating at least one network energy saving, NES, cell, the access network node comprising: means for transmitting, to the UE, a message comprising information relating to measurement opportunities for the at least one NES cell, to allow the UE to measure signals transmitted by the at least one second cell.

The information may comprise location information in respect of the at least one NES cell to allow the UE to decide whether or not to trigger a measurement of the at least one NES cell using the location information.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a method for a user equipment, UE, in a telecommunication system comprising a first access network node operating a first cell and a plurality of second access network nodes operating respective network energy saving, NES, cells, the method comprising: receiving, from the first access network node, information indicating measurement opportunities for the plurality of NES cells; transmitting, to the first access network node, a list of NES cells for the UE to measure; receiving, from the first access network node, a cell list comprising at least one NES cell of the plurality of NES cells for the UE to measure; and acquiring measurements of the at least one NES cell based on the received cell list and a measurement opportunity indicated by the information, for the at least one NES cell.

Transmitting to the first access network node may further comprise transmitting UE-specific location information.

The UE-specific location information may only be provided in a case where the UE is connected to the first cell.

The information may comprise location information in respect of the plurality of NES cells to allow the UE to decide which NES cells to include in the list of NES cells the UE transmits to the first access network node.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a method for a first access network node operating a first cell in a telecommunication system, the telecommunication system further comprising a user equipment, UE, and a plurality of second access network nodes operating a respective network energy saving, NES, cell, the method comprising: transmitting, to the UE, information indicating measurement opportunities for the plurality of NES cells; receiving, from the UE, a list of NES cells for the UE to measure; and transmitting, to the UE, a cell list comprising at least one NES cell of the plurality of NES cells for the UE to measure.

The receiving from the UE may further comprise receiving UE-specific location information.

The UE-specific location information may only be provided in a case where the UE is connected to the first cell.

The method may further comprise, in a case where the cell list includes a dormant NES cell operating in a dormant energy saving state, transmitting an activation signal to the dormant NES cell to cause the dormant NES cell to activate and broadcast synchronization signals to allow the UE to measure the dormant NES cell.

The activation signal may identify resources to be used by the dormant NES cell to transmit its synchronization signals corresponding to the measurement opportunities indicated to the UE in the information for that dormant NES cell.

The information may comprise location information in respect of the NES cells to allow the UE to decide which NES cells to include in the list of NES cells the UE transmits to the first access network node.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a method for a second access network node operating a network energy saving, NES, cell in a dormant state, the telecommunication system further comprising a user equipment, UE, and a first access network node operating a first cell, the method comprising: receiving, from the first access network node, an activation signal causing the dormant NES cell to activate and broadcast synchronization signals to allow the UE to measure the dormant NES cell.

The activation signal may identify resources to be used by the dormant NES cell to transmit its synchronization signals.

In another aspect the disclosure provides a user equipment, UE, in a telecommunication system comprising a first access network node operating a first cell and a plurality of second access network nodes operating respective network energy saving, NES, cells, the UE comprising: means for receiving, from the first access network node, information indicating measurement opportunities for the plurality of NES cells; means for transmitting, to the first access network node, a list of NES cells for the UE to measure; means for receiving, from the first access network node, a cell list comprising at least one NES cell of the plurality of NES cells for the UE to measure; and means for acquiring measurements of the at least one NES cell based on the received cell list and a measurement opportunity indicated by the information, for the at least one NES cell.

The transmission to the first access network node may further comprise UE-specific location information.

The UE-specific location information may only be provided in a case where the UE is connected to the first cell.

The information may comprise location information in respect of the plurality of NES cells to allow the UE to decide which NES cells to include in the list of NES cells the UE transmits to the first access network node.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a first access network node configured to operate a first cell in a telecommunication system, the telecommunication system further comprising a user equipment, UE, and a plurality of second access network nodes operating a respective network energy saving, NES, cell, the first access node comprising: means for transmitting, to the UE, information indicating measurement opportunities for the plurality of NES cells; means for receiving, from the UE, a list of NES cells for the UE to measure; and means for transmitting, to the UE, a cell list comprising at least one NES cell of the plurality of NES cells for the UE to measure.

The receiving from the UE may further comprise receiving UE-specific location information.

The UE-specific location information may only be provided in a case where the UE is connected to the first cell.

The first access network node may further comprise, in a case where the cell list includes a dormant NES cell operating in a dormant energy saving state, means for transmitting an activation signal to the dormant NES cell to cause the dormant NES cell to activate and broadcast synchronization signals to allow the UE to measure the dormant NES cell.

The activation signal may identify resources to be used by the dormant NES cell to transmit its synchronization signals corresponding to the measurement opportunities indicated to the UE in the information for that dormant NES cell.

The information may comprise location information in respect of the NES cells to allow the UE to decide which NES cells to include in the list of NES cells the UE transmits to the first access network node.

The location information may comprise one or more of: coordinates of the at least one NES cell, beam profile information of the at least one NES cell having the same beam profile as the UE, beam strength information, the physical distance of the UE from the first cell, and the physical distance of the UE from the at least one NES cell.

In another aspect the disclosure provides a second access network node configured to operate a network energy saving, NES, cell in a dormant state, the telecommunication system further comprising a user equipment, UE, and a first access network node operating a first cell, the second access node comprising: means for receiving, from the first access network node, an activation signal causing the dormant NES cell to activate and broadcast synchronization signals to allow the UE to measure the dormant NES cell.

The activation signal may identify resources to be used by the dormant NES cell to transmit its synchronization signals.

In another aspect the disclosure provides a method for a user equipment, UE, in a telecommunication system comprising a first access network node operating a first cell and a plurality of second access network nodes respectively operating network energy saving, NES, cells, the method comprising: transmitting, to the first access network node, a request for cell measurement information of NES cells; receiving a cell list, from the first access network node, comprising information indicating measurement opportunities for at least one NES cell for the UE to measure; and acquiring measurements of the at least one NES cell based on the received information.

The request for cell measurements may further comprise UE-specific location information.

The UE-specific location information may only be provided in a case where the UE is connected to the first cell.

In another aspect the disclosure provides a method for a first access network node operating a first cell in a telecommunication system, the telecommunication system further comprising a user equipment, UE, and a plurality of second access network nodes operating respective network energy saving, NES, cells, the method comprising: receiving, from the UE, a request for cell measurement information of NES cells; determining a cell list comprising measurement opportunity information for at least one suitable NES cell for the UE to measure; and transmitting, to the UE, the cell list.

The request for cell measurement information may further comprise UE-specific location information in a case where the UE is connected to the first cell.

The method may further comprise, in the case where the UE requests measurement of a second cell operating in a dormant energy saving state, transmitting an activation signal to the dormant NES cell to cause the dormant NES cell to activate and broadcast synchronization signals to allow the UE to measure the dormant NES cell.

The activation signal may identify resources to be used by the dormant NES cell to transmit its synchronization signals corresponding to the measurement opportunities of the dormant NES cell indicated to the UE in cell list.

In another aspect the disclosure provides a user equipment, UE, in a telecommunication system comprising a first access network node operating a first cell and a plurality of second access network nodes respectively operating network energy saving, NES, cells, the UE comprising: means for transmitting, to the first access network node, a request for cell measurement information of NES cells; means for receiving a cell list, from the first access network node, comprising information indicating measurement opportunities for at least one NES cell for the UE to measure; and means for acquiring measurements of the at least one NES cell based on the received information.

The request for cell measurements may further comprise UE-specific location information.

The UE-specific location information may only be provided in a case where the UE is connected to the first cell.

In another aspect the disclosure provides a first access network node configured to operate a first cell in a telecommunication system, the telecommunication system further comprising a user equipment, UE, and a plurality of second access network nodes operating respective network energy saving, NES, cells, the first access node comprising: means for receiving, from the UE, a request for cell measurement information of NES cells; means for determining a cell list comprising measurement opportunity information for at least one suitable NES cell for the UE to measure; and means for transmitting, to the UE, the cell list.

The request for cell measurement information may further comprise UE-specific location information in a case where the UE is connected to the first cell.

The first access network may further comprise, in the case where the UE requests measurement of a second cell operating in a dormant energy saving state, means for transmitting an activation signal to the dormant NES cell to cause the dormant NES cell to activate and broadcast synchronization signals to allow the UE to measure the dormant NES cell.

The activation signal may identify resources to be used by the dormant NES cell to transmit its synchronization signals corresponding to the measurement opportunities of the dormant NES cell indicated to the UE in cell list.

In another aspect the disclosure provides a method performed by a user equipment, UE, in a telecommunication system, the telecommunication system further comprising a first access network node operating a first cell and at least one second access network node operating a network energy saving, NES, cell, the method comprising: triggering transmission of a wakeup signal, WUS, to the first access network node and/or to the at least one second access network node in a case where the UE satisfies a WUS trigger threshold.

The WUS may comprise a reference signal which configures the receiving first access network node and/or second access network node to interpret the presence of the UE, or; wherein the WUS may comprise at least one of: information relating to UE's radio quality relative to at least one NES cell, the UE's desired quality of service, a cause value, or an ordered list of suitable NES cells.

The method may further comprise receiving a reply from the first cell and/or the NES cell and in a case where the reply indicates that the WUS was successful, using updated system information of the at least one NES cell to access the at least one NES cell.

The method may further comprise receiving a reply from the first cell and/or the NES cell and in a case where the reply originates from the first access network node and indicates that the WUS was not successful, the reply message may comprise information indicating the at least one NES cell which did not wakeup and which may configure the UE for treating the at least one NES cell as unsuitable for measurement for a period of time.

The method may further comprise receiving a reply from the first cell and/or the NES cell and in a case where the reply originates from the second access network node and indicates that the WUS was not successful, the reply message may comprise information indicating the second cell did not wakeup and which may configure the UE for treating the second cell as unsuitable for measurement for a period of time.

The reply message may be a broadcast acknowledgement reply message, or the reply message may be a dedicated acknowledgement reply message for the UE.

In another aspect the disclosure provides a user equipment, UE, in a telecommunication system, the telecommunication system further comprising a first access network node operating a first cell and at least one second access network node operating a network energy saving, NES, cell, the UE comprising: means for triggering transmission of a wakeup signal, WUS, to the first access network node and/or to the at least one second access network node in a case where the UE satisfies a WUS trigger threshold.

The WUS may comprise a reference signal which may configure the receiving first access network node and/or second access network node to interpret the presence of the UE, or; wherein the WUS may comprise at least one of: information relating to UE's radio quality relative to at least one NES cell, the UE's desired quality of service, a cause value, or an ordered list of suitable NES cells.

The UE may further comprise means for receiving a reply from the first cell and/or the NES cell and in a case where the reply indicates that the WUS was successful, the UE may be configured to use updated system information of the at least one NES cell to access the at least one NES cell.

The UE may further comprise means for receiving a reply from the first cell and/or the NES cell and in a case where the reply originates from the first access network node and indicates that the WUS was not successful, the reply message may comprise information indicating the at least one NES cell which did not wakeup and which may configure the UE to treat the at least one NES cell as unsuitable for measurement for a period of time.

The UE may further comprise means for receiving a reply from the first cell and/or the NES cell and in a case where the reply originates from the second access network node and indicates that the WUS was not successful, the reply message may comprise information indicating the second cell did not wakeup and which may configure the UE to treat the second cell as unsuitable for measurement for a period of time.

The reply message may be a broadcast acknowledgement reply message, or the reply message may be a dedicated acknowledgement reply message for the UE.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system;

FIG. 2 illustrates a typical frame structure that may be used in the telecommunication system of FIG. 1;

FIG. 3 illustrates an example of a DRX cycle;

FIG. 4 illustrates a UE within the coverage of an anchor cell and four cells operating in a NES state;

FIG. 5 illustrates an example of an anchor cell assisting a UE to acquire measurements of non-dormant NES cells;

FIG. 6A illustrates the radio environment about a UE, an anchor cell and a cell operating in a NES state;

FIG. 6B illustrates a UE in the vicinity of eight beams being transmitted by a base station;

FIG. 6C graphically illustrates a UE's beam profile;

FIG. 7 illustrates another example of an anchor cell assisting a UE to acquire measurements of NES cells;

FIG. 8 illustrates an example of a UE assisting an anchor cell to acquire measurements of NES cells;

FIG. 9 illustrates another example of a UE assisting an anchor cell to acquire measurements of NES cells;

FIG. 10 illustrates a wake-up procedure triggered by a UE;

FIG. 11 is a schematic block diagram illustrating the main components of a UE for the telecommunication system of FIG. 1; and

FIG. 12 is a schematic block diagram illustrating the main components of a base station for the telecommunication system of FIG. 1.

### DESCRIPTION OF EMBODIMENTS

### Overview

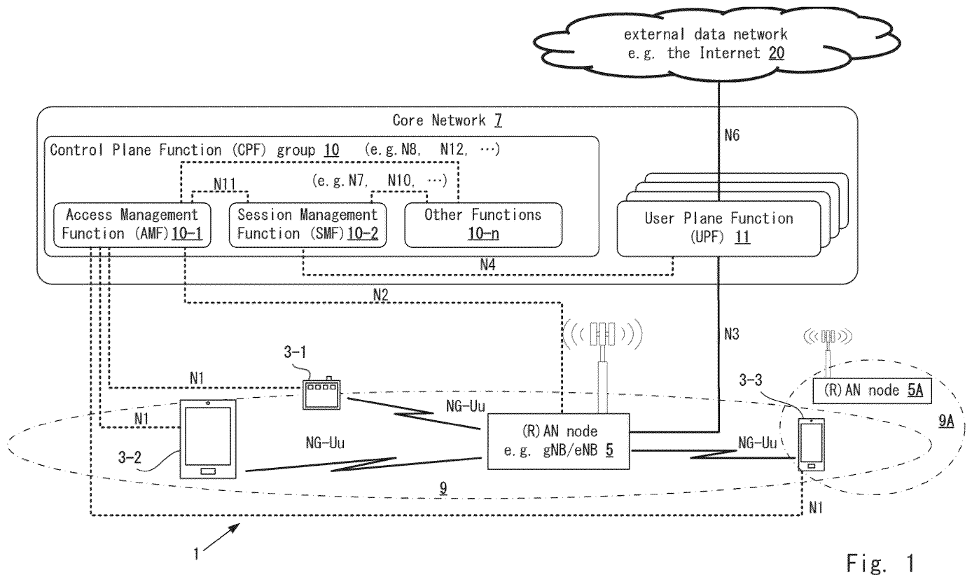

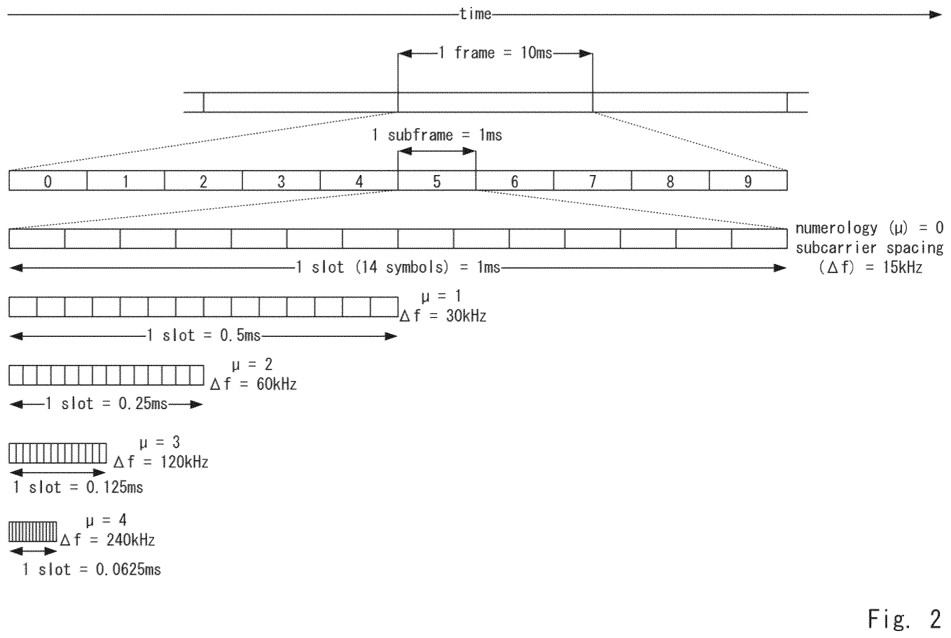

An exemplary telecommunication system will now be described in general terms, by way of example only, with reference to FIGS. 1 and 2.

FIG. 1 schematically illustrates a mobile (‘cellular’ or ‘wireless’) communication system 1 to which example embodiments of the present disclosure are applicable.

In the communication system 1 user equipment (UEs) 3-1, 3-2, 3-3 (e.g. mobile telephones and/or other devices capable of telecommunication) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g. a 5G core network or evolved packet core network (EPC)). The N2 and N3 interfaces between RAN node 5 and the 5G core network are illustrated, though it will be appreciated one or more alternative interfaces may be used e.g. depending on the nature of the connection partner in the core network 7. Also illustrated in FIG. 1 is an additional RAN node 5A, which may operate one or more associated cells 9A. In the illustrated example, the cell 9A operated by RAN node 5A provides a smaller coverage area than the cell 9 operated by RAN node 5 (RAN node 5A's interfaces with the core network have been omitted for clarity).

As those skilled in the art will appreciate, whilst three UEs 3 and two base stations 5 are shown in FIG. 1 for illustration purposes, the network, when implemented, will typically include additional base stations 5 and UEs 3.

Each base station 5 controls the associated one or more cells 9 either directly, or indirectly via one or more other nodes (such as home base stations, relays, remote radio heads, distributed units, and/or the like). It will be appreciated that the base stations 5 may be configured to support 4G, 5G, 6G, and/or any other 3GPP or non-3GPP communication protocols.

The UEs 3 and their serving base station 5 are connected via an appropriate air interface (for example the so-called ‘Uu’ interface or the like). Neighbouring base stations 5 may be connected to each other via an appropriate base station to base station interface (such as the so-called ‘X2’ interface, ‘Xn’ interface, or the like, which has been omitted for clarity in FIG. 1).

The core network 7 includes a number of logical nodes (or ‘functions’) for supporting communication in the communication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g. an IP network such as the Internet) via reference point N6 for communication of the user data.

The AMF 10-1 performs mobility management related functions, maintains the NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

The base stations 5 of the communication system 1 are configured to operate at least one cell 9 on an associated frequency division duplex (FDD) carrier that operates in paired spectrum. It will be appreciated that base stations 5 may also operate at least one cell 9 on an associated time division duplex (TDD) carrier that operates in unpaired spectrum.

The base station 5 may be a base station 5 that is split between one or more distributed units (DUs) and a central unit (CU) (omitted from FIG. 1 for clarity), with a CU typically performing higher level functions and communication with the next generation core, and with the DU 50 performing lower level functions and communication over an air interface with UEs 3 in the vicinity (i.e. in a cell operated by the base station 5). This type of base station may be referred to as a ‘distributed’ base station 5 or gNB 5. A distributed gNB 5 includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station 5 may be split into separate control-plane and user-plane entities, each of which may include an associated transceiver circuit, antenna, network interface, controller, memory, operating system, and communications control module. When the base station 5 comprises a distributed base station, the network interface also includes an E1 interface and an F1 interface (F1-C for the control plane and F1-U for the user plane) to communicate signals between respective functions of the distributed base station.

The base station 5 is also configured for transmission of, and the UEs 3 are configured for the reception of, control information and user data via a number of downlink (DL) physical channels and for transmission of a number of physical signals. The DL physical channels correspond to resource elements (REs) carrying information originated from a higher layer, and the DL physical signals are used in the physical layer and correspond to REs which do not carry information originated from a higher layer.

The physical channels may include, for example, a physical downlink shared channel (PDSCH), a physical broadcast channel (PBCH), and a physical downlink control channel (PDCCH). The PDSCH carries data sharing the PDSCH's capacity on a time and frequency basis. The PDSCH can carry a variety of items of data including, for example, user data, UE-specific higher layer control messages mapped down from higher channels, system information blocks (SIBs), and paging. The PDCCH carries downlink control information (DCI) for supporting a number of functions including, for example, scheduling the downlink transmissions on the PDSCH and also the uplink data transmissions on a physical uplink shared channel (PUSCH). The PBCH provides UEs 3 with the Master Information Block, MIB. It also, in conjunction with the PDCCH, supports the synchronisation of time and frequency, which aids cell acquisition, selection and re-selection. The UE 3 may receive a Synchronization Signal Block (SSB), and the UE 3 may assume that reception occasions of a PBCH, primary synchronization signal (PSS) and secondary synchronization signal (SSS) are in consecutive symbols and form a SS/PBCH block. The base station 5 may transmit a number of synchronization signal (SS) blocks corresponding to different DL beams. The total number of SS blocks may be confined, for example, within a 5 ms duration as an SS burst. The periodicity of the SSB transmissions may be indicated to the UE using any suitable signalling (e.g. per serving cell using ssb-periodicityServingCell). The periodicity value for the SSB may be, for example, greater than or equal to 20 ms. For initial cell selection, the UE 3 may be configured to assume that an SS burst occurs with a periodicity of 2 frames. The UE 3 may also be provided with an indication of which SSBs within a 5 ms duration are transmitted (e.g. using ssb-Positions InBurst).

The DL physical signals may include, for example, reference signals (RSS) and synchronization signals (SSs). A reference signal (sometimes known as a pilot signal) is a signal with a predefined special waveform known to both the UE 3 and the base station 5. The reference signals may include, for example, cell specific reference signals, UE-specific reference signal (UE-RS), downlink demodulation signals (DMRS), and channel state information reference signal (CSI-RS).

Similarly, the UEs 3 are configured for transmission of, and the base stations 5 are configured for the reception of, control information and user data via a number of uplink (UL) physical channels corresponding to REs carrying information originated from a higher layer, and UL physical signals which are used in the physical layer and correspond to REs which do not carry information originated from a higher layer. The physical channels may include, for example, the PUSCH, a physical uplink control channel (PUCCH), and/or a physical random-access channel (PRACH). The UL physical signals may include, for example, demodulation reference signals (DMRS) for an UL control/data signal, and/or sounding reference signals (SRS) used for UL channel measurement.

When the UE 3 initially establishes a radio resource control (RRC) connection with a base station 5 via a cell it registers with an appropriate core network node (e.g, AMF, MME). The UE 3 is in the so-called RRC connected state and an associated UE context is maintained by the network. When the UE 3 is in the so-called RRC idle or in the RRC inactive state, it selects an appropriate cell for camping so that the network is aware of the approximate location of the UE 3 (although not necessarily on a cell level).

### Frame Structure

Referring to FIG. 2, which illustrates the typical frame structure that may be used in the communication system 1, the base stations 5 and UEs 3 of the communication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the communication system 1 supports multiple different numerologies (subcarrier spacing (SCS), slot lengths and hence OFDM symbol lengths). Specifically, each numerology is identified by a parameter, μ, where μ=0 represents 15 kHz (corresponding to the LTE SCS). Currently, the SCS for other values of μ can, in effect, be derived from μ=0 by scaling up in powers of 2 (i.e. SCS=15×2u kHz). The relationship between the parameter, μ, and SCS (Δf) is as shown in Table 1:

TABLE 1
5G Numerology

| | | Number of slots | |
|---|---|---|---|
| μ | Δf = 2^{μ} · 15[kHz] | per subframe | Slot length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

### System Information and SIB

It will be appreciated that transmissions in a cell of a given base station in a telecommunication network may include one or more broadcast transmissions and one or more unicast transmissions for reception by a UE's in that network. System information (SI) transmitted in a cell may include ‘minimum SI’ (MSI) and ‘other SI’ (OSI). The OSI may be broadcast on-demand, for example using a downlink shared channel (DL-SCH). The OSI may be broadcast upon request from a UE 3 that is in a radio resource control (RRC) idle or RRC inactive state. The OSI may also be requested by a UE 3 that is in the RRC connected state, for example via one or more dedicated RRC transmissions.

The SI may include information for enabling (e.g. configuring) the UE 3 to complete a cell (re)selection (discussed below), may include information for enabling the UE 3 to complete a cell reselection procedure, or for enabling the UE 3 to receive one or more paging messages transmitted in a cell. SI may be broadcast using a Master Information Block (MIB) and one or more System Information Blocks (SIB). The UE 3 in FIG. 1 may receive a stronger signal and/or a higher quality signal from a given base station relative to a base station which the UE is connected to/camped on. In this case, the UE triggers the cell reselection procedure, and hence camps on the cell which provides the UE with a better service.

The MSI comprises the MIB and system information block 1 (SIB1). The MIB includes information for use by a UE 3 to receive SIBI, for example a subcarrier spacing for SIB1. The MIB provides information corresponding to a Control Resource Set (CORESET) and Search Space. SIB1 may be referred to as ‘remaining MSI’ (RMSI). SIB1 may be transmitted in a dedicated RRC message, and other SIBs (e.g. SIB2 to SIB9) may be transmitted using one or more other suitable RRC transmissions. The MIB and SIB1 may provide the UE 3 with an indication of scheduling information for receiving and decoding the other SIB, such as SIB2 to SIB9, and may provide information for use by the UE 3 to receive one or more paging messages.

The OSI may comprise, for example, SIB2 to SIB9 transmitted using a DL-SCH in SI messages. A mapping of SIB2 to SIB9 to corresponding SI messages may be provided to the UE 3 by the base station 5. MIB and SIBI to SIB9 are described in more detail, for example, in 3GPP TS 38.331. For example, SIB2 provides information for intra-frequency, inter-frequency and inter-system cell reselection, SIB3 provides cell-specific information for intra-frequency cell reselection, and SIB4 provides information for inter-frequency cell reselection. SIB5 provides information regarding inter-system cell reselection towards 4G (LTE). SIB6 and SIB7 provide information for an earthquake and tsunami warning system (ETWS). SIB8 provides information for a commercial mobile alert service (CMAS) notification, for example to provide warning text messages to the UE 3. SIB9 includes information regarding coordinated universal time (UTC), global positioning system (GPS) time (e.g. for GPS initialisation) and local time.

SIBs may be broadcast periodically (e.g. according to a predetermined periodic pattern), or alternatively may be provided ‘on-demand’, for example in response to a request from a UE 3. For example, MIB may be transmitted with a periodicity of 80 ms and repetitions made within 80 ms, and SIB1 may be transmitted with a periodicity of 160 ms and a variable transmission repetition periodicity within 160 ms (e.g. 20 ms). SIB1 can be used to indicate to a UE 3 which SIBs are transmitted periodically and which SIBs are available on-demand in response to a request from the UE 3. A UE 3 may be configured to request an on-demand SIB using MSG1 (random access preamble (RA)), which may be referred to as a MSG1-based on-demand SI request, or MSG3 (RRC Connection Request), which may be referred to as a MSG3-based on-demand SI request.

A physical broadcast channel (PBCH) can be used to broadcast the MIB. The base station 5 may transmit the PBCH with synchronisation signals (SS) (e.g. primary synchronisation signal (PSS) and secondary synchronisation signal (SSS)) in a SS/PBCH Block. The SS/PBCH block comprises four orthogonal frequency-division multiplexed (OFDM) symbols that are mapped to PSS, SSS and PBCH associated with a demodulation reference signal (DM-RS). In the frequency domain, an SS/PBCH block consists of 240 contiguous subcarriers. When the UE 3 is in an RRC connected mode, the base station 5 may provide the UE 3 with an indication of resources used for the SS/PBCH, for example using dedicated signalling (e.g. for an anchor NES cell or a non-anchor NES cell). SIB1 may be transmitted using a physical downlink shared channel (PDSCH). The OSI may be similarly transmitted, for example, using a PDSCH.

When one or more beamformed transmissions are transmitted in a cell provided by the base station 5, some of the SI (e.g. some of the SIB) may only be transmitted using particular beams, or using a particular transmission/reception point (TRP).

### Discontinuous Reception

A device (e.g. a UE 3) may be configured to operate using a discontinuous reception (DRX) method. In a DRX method, the UE 3 is configured with a DRX cycle that includes periods in which the UE 3 is configured for receiving transmissions, and periods in which the UE 3 is not configured for receiving transmissions (e.g. transmissions from a base station 5). The period in which the UE 3 is not configured for receiving transmissions may be a period in which physical layer processing is turned off. Advantageously, the energy consumption of the UE 3 is reduced in the periods in which the UE 3 is not configured for receiving transmissions.

The UE 3 may be provided with a configuration for the DRX by the network (e.g. by or via the base station 5). A DRX configuration provided to the UE 3 (for example, using a DRX configuration information element (IE) included in a transmission from the base station 5 to the UE 3) may include an indication of a time period for which the UE 3 is to be configured in a state in which the UE 3 does not receive and decode downlink transmissions, and an indication of a time period for which the UE 3 is to be configured for receiving downlink transmissions (e.g. a multicast or unicast transmission from the base station 5). The DRX configuration may include a time offset for the DRX cycle, which may be useful for controlling the relative timing of the DRX cycles of different UEs 3 (e.g. to synchronise or offset the DRX cycles). The DRX configuration may include an indication of a period in which the UE is to remain configured for receiving transmissions following the reception of a PDCCH.

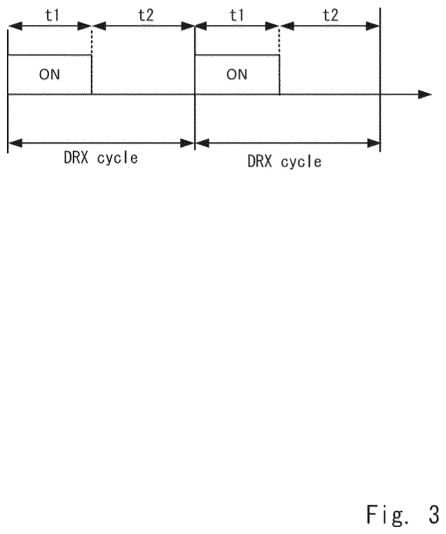

The period in which the UE 3 is configured for receiving transmissions during the DRX cycle may be referred to as an ‘ON’ period or ‘DRX active time’, and the period in which the UE 3 is not configured for receiving transmissions may be referred to as an ‘OFF’ period, ‘sleep period’, or ‘DRX inactive time’. An illustration of an ON period having a duration t1, and an OFF period having a duration t2, within a repeating DRX cycle is illustrated in FIG. 3.

DRX may be configured per UE 3 by the network (e.g. via any suitable signalling from the base station 5). For example, the timing and/or duration of the ON periods in the DRX cycle may be different for different UEs 3. During the OFF periods, the UE 3 may be configured to not monitor a PDCCH, but may initiate an uplink transmission based on configured resources (for example, using a PUCCH, a random access channel (RACH), scheduling request (SR) or a configured grant PUSCH (CG-PUSCH)). During an OFF period, the system may be configured for no transmission/reception between the UE 3 and the base station 5 in a corresponding cell. The base station 5 may nevertheless be configured for reduced or limited transmission/reception in the cell during the OFF period of the DRX cycle. For example, the base station 5 may be configured not to transmit only a subset of periodic signals or channels, such as common channels/signals or UE-specific channels/signals that would normally be transmitted in the cell.

DRX may be used when the UE 3 is in an RRC idle mode or when the UE 3 is in an RRC connected mode. For example, DRX may be used when the UE 3 is in an RRC idle mode to control the monitoring of paging messages transmitted by the base station 5. This advantageously prevents the UE 3 from monitoring all of the PDCCH transmission opportunities, thereby reducing the energy usage of the UE 3. Similarly, DRX may be used when the UE 3 is in the RRC connected state (referred to as C-DRX) to reduce the energy usage of the UE 3, for example by configuring periods in which the UE 3 is not required to monitor a PDCCH.

Within a C-DRX cycle, when the UE 3 is in an RRC connected state, the UE 3 periodically monitors the PDCCH during the ON periods, and does not monitor PDCCH outside of the ON periods (i.e. in the DRX inactive periods), thereby beneficially reducing the power consumption of the UE 3. Currently, during a C-DRX inactive time, the UE 3 is allowed to initiate an uplink transmission based on configured resources (for example, using a PUCCH, a random access channel (RACH), scheduling request (SR) or on a configured grant PUSCH (CG-PUSCH)).

Outside of the DRX active periods, the base station 5 may be configured to reduce (e.g., temporarily increase the periodicity) or disable transmissions and channels such as SSB/SI/paging/RACH to reduce energy consumption at the base station 5. As will be described in more detail later, when the UE 3 determines to transmit/receive DL/UL signals and channels outside of the DRX active period, an uplink wakeup signal (UL WUS) can be used to request transmitting/receiving the corresponding DL/UL signals and channels.

A DRX configuration may include a long DRX cycle in which the time between the ON periods is relatively large (t2 shown in FIG. 3 is relatively large), and a short DRX cycle in which the time between the ON periods is relatively small (t2 shown in FIG. 3 is relatively small). Whilst the long DRX cycle improves the energy efficiency of the system (because the overall percentage of time in which the UE 3 is in the ON state is smaller), latency of communications may be increased because the base station 5 cannot communicate with the UE 3 via downlink transmissions when the UE 3 is in the sleep state (the DRX inactive state). When the UE 3 is configured to use DRX after a period of inactivity following a data transfer, the UE 3 may be configured to initially use the short DRX cycle configuration (alternatively, the UE 3 may be controlled to begin DRX using the short DRX configuration, following the data transfer, based on signalling from the base station 5 such as a medium access control (MAC) control element (CE), or any other suitable signalling that indicates that the UE 3 should begin DRX). After a further period of time (which may be referred to as the Short DRX Cycle timer) the UE 3 may then operate using the long DRX cycle configuration. The short and long DRX configurations may be indicated to the UE 3, for example, using any suitable signalling from the base station 5 (or alternatively could be preconfigured at the UE 3).

The UE 3 may be configured to provide assistance information (UE assistance information) to the network for use by the network in configuring the DRX cycle. The assistance information may be transmitted, for example, from the UE 3 to the base station 5 following an RRC reconfiguration procedure.

Whilst DRX has been described above with reference to discontinuous reception performed by the UE 3, a similar DTX pattern can be defined to control the discontinuous transmission of data by the UE 3. When defined, the UE DTX pattern typically overlaps with the UE DRX pattern-so that when the UE 3 is not receiving data it is also normally not transmitting data.

It should be appreciated that such methods may analogously be employed by base station 5, e.g. by a DRX method or by a discontinuous transmission (DTX) method, and thereby stopping the base station's transmissions and receptions during periods of time (OFF duration) when the base station 5 is inactive or asleep and resuming transmissions and receptions with the UEs 3 during periods of time (ON duration) when the base station 5 is active. Moreover, other network energy saving techniques may be employed by base station 5, e.g. by use of NES techniques in at least one of the time/frequency/spatial/power domains.

Measurement, Selection and Wakeup of Cells Operating in a NES State As mentioned above, base stations 5 in communication system 1 may use NES techniques in time/frequency/spatial/power domains to operate in a more energy efficient manner. One consequence of such operations is that the base station 5 may transition to a dormant power state/energy saving state (e.g., an SSB-less/SIB1-less/SSB relaxed state). A base station operating in such a NES state may be fully dormant, and hence not transmit/receive signals until its NES state is modified, or the base station may operate in a NES state where the number of signals it transmits/is able to receive is reduced. Whilst such operations can save energy, there may be instances where a UE would benefit from communicating via a cell which would have otherwise been operated in a non-NES state by the base station 5.

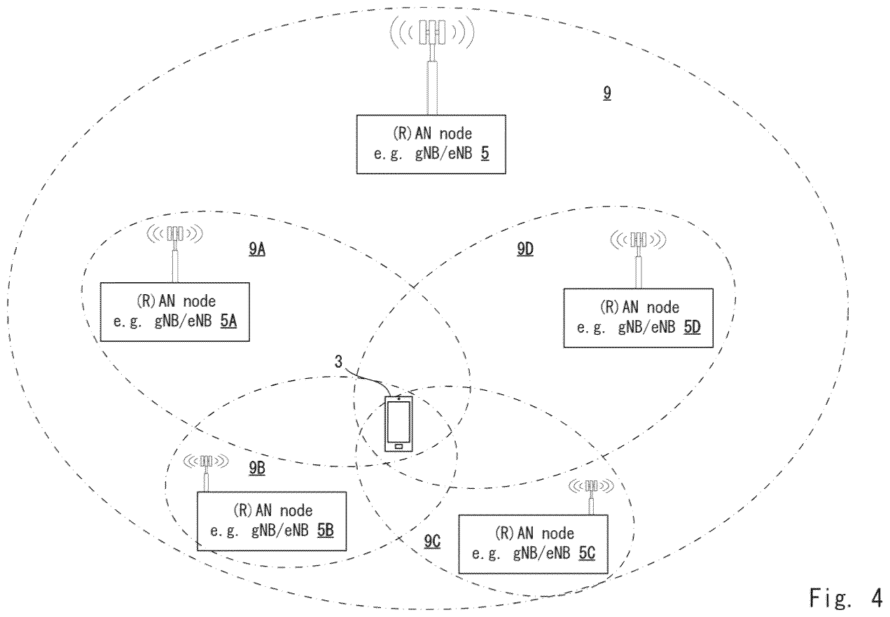

For example, with reference to FIG. 4, UE 3 is in the coverage of base stations 5, 5A, 5B, 5C and 5D (via cells 9, 9A, 9B, 9C and 9D respectively operated by each base station). Base stations 5A-D can operate in a NES state (and hence their cells 9A-D may be referred to as “NES cells”), whereas base station 5 does not operate in a NES state (and hence its cell 9 can be referred to as an “anchor cell”, as the UE 3 is able to receive SSB, system information and paging in this cell 9 from base station 5).

In this example of FIG. 4, UE 3 is being served by base station 5B because it receives the strongest signal from its most proximal base station 5B, relative to the other base stations which are further away. However, if cell 9B malfunctions (e.g. due to equipment failure at base station 5B), and base stations 5A, 5C and 5D are in a NES state, then the UE may not be able to communicate with the core network 7 via the cells 9A, 9C and 9D of these base stations during a cell reselection procedure. For instance, some NES states may result in the base station transmitting and/or receiving at a reduced rate relative to its non-NES operation, and hence UEs may not be able make measurements of such NES cells in a case where the UE happens to scan for cells at a time when the NES cell is transmitting at its reduced rate. Of course, if the NES state renders the NES cell entirely dormant (or in a “deep sleep” state) the UE 3 will not be able to scan those cells at all. Accordingly, mechanisms which make UEs aware of base stations which are operating in a NES-state when the UE performs cell (re)selection are needed.

### Proposal 1a

One way to make UEs aware of NES cells during cell (re)selection is to do so through appropriate network planning. For example, frequencies may be reused efficiently (i.e. frequencies “dedicated” to NES cells where a UE can find the closest one). However, because not all NES cells may be discoverable (or be available), and because even with frequency reuse, NES states for NES cells using the same frequency may differ throughout the anchor cell, additional information may be necessary to identify suitable NES cells, such as the specific location of one or more NES cells, and hence frequency reuse alone may not be sufficient for the UE to identify one or more NES cells suitable for measurement.

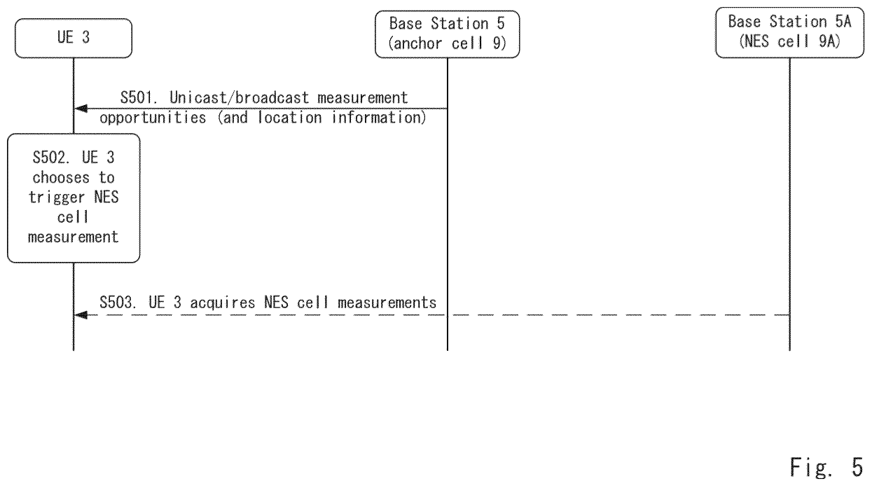

For instance, with reference to FIG. 5, if UE 3 during cell selection (or cell reselection) does not determine the presence of one or more suitable NES cells, but detects an anchor cell 9, that anchor cell 9 may be configured for providing information to the UE 3 to assist the UE to measure one or more NES cells that are only configured for periodic broadcast/reception of signals (e.g. periodic broadcasts of SSBs due to operating in a NES state). In S501, anchor cell 9 is configured for unicasting or broadcasting measurement opportunities in respect of NES cells which may be relevant for UE 3, e.g. information in respect of timings which indicate when and on what frequencies those NES cells are scheduled to transmit their synchronization/reference signals. Optionally, this unicast or broadcast may include location information in respect of the NES cells. In this regard, the location information may provide the exact coordinates of one or more NES cells, thereby assisting the UE 3 to subsequently choose to measure one or more NES cells which are proximate to it, and the measurement opportunities may indicate times at which the NES cell is configured to broadcast/receive signals. However, it will be appreciated that the exact coordinates of a given NES cell (or NES cells) are not necessarily needed, as instead the location information may take other forms which assist the UE 3 in selecting NES cells to measure, such as beam profile information, beam strength information (e.g. of second cells having the same beam profile as the UE), the UE's physical distance from the anchor cell, the UE's closest neighbor cells, etc. Then, in S502, the UE 3 may decide whether or not to trigger NES cell measurements based on the information received from the anchor cell in S501. Accordingly, should UE 3 decide to trigger NES cell measurements, the UE 3 in S503 is then able to acquire NES cell measurements for NES cells which it may otherwise have been unable to measure.

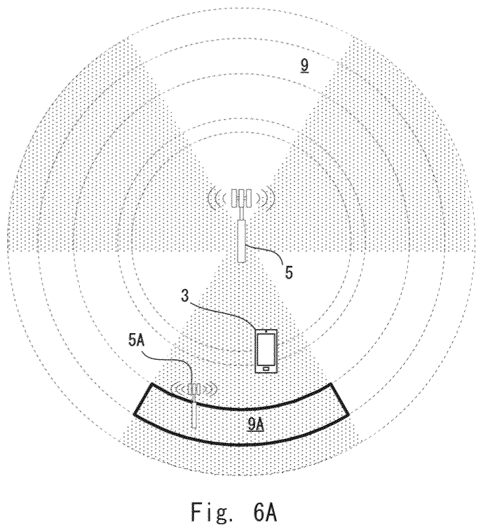

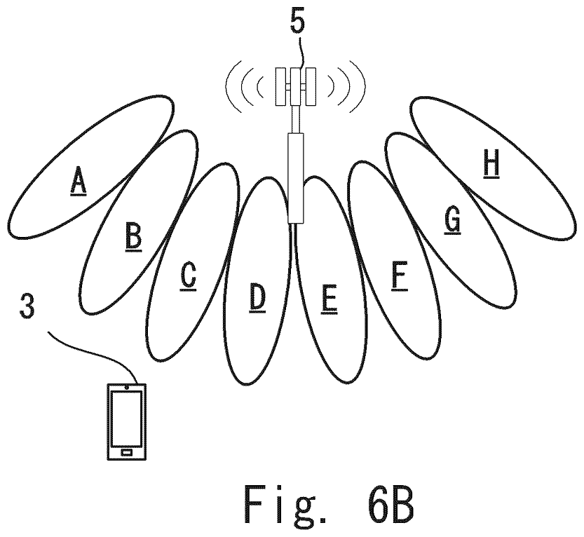

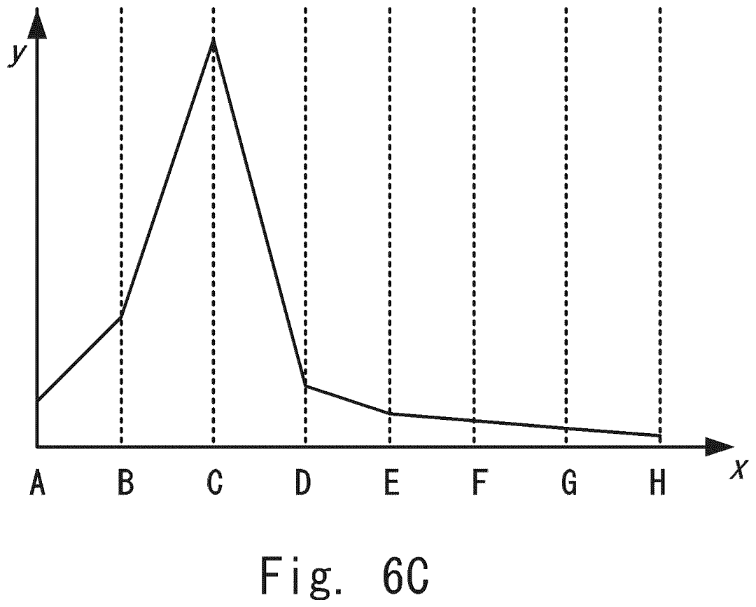

For example, with reference to FIG. 6A, UE 3 and base stations 5 and 5A are illustrated. Base station 5 operates a cell 9 having a larger coverage area relative to a cell 9A operated by base station 5A (and in this example, base station 5 is considered UE 3's anchor cell, and cell 9A is a NES cell). Base station 5 is configured to help UEs to select potentially suitable NES cells for measurements by unicast/broadcast of measurement opportunities and potentially location information as described above with reference to FIG. 5, and hence UE 3 is able to measure cell 9A based on the received information (without which, it may otherwise not have been able to measure the signals transmitted by the NES cell 9A).

As illustrated in FIG. 6A, base station 5 has several beams (illustrated by the alternating shaded and unshaded areas of cell 9). UE 3 is located in an area of cell 9 corresponding to one of the shaded beams, and hence the UE 3 has a “beam profile” with respect to the other beams. This “beam profile” is illustrated with reference to in FIGS. 6B and 6C. In FIG. 6B, 8 beams A to H are schematically illustrated and point in different directions relative to the UE 3. Accordingly, the UE 3 receives signals via those beams to differing extents, as illustrated in FIG. 6C (the Y-axis may represent received strength/received quality, etc.). Base station 5 may provide information to UE 3 which indicates the beam profiles of one or more NES cells which are within the coverage of this beam profile, (one or more NES cells beam profile may be simulated by the anchor cell 9 knowing the real position of the NES cell 9A, or the NES cell 9A could perform actual beam measurements and report to the anchor cell 9). If the UE 3 has a beam profile which corresponds (or closely corresponds) to a NES cell beam profile, then the UE 3 can assume that it could be in the NES cell's coverage, and hence is a potential candidate to be measured by UE 3. Additionally, base station 5 may also (or instead) include information in its unicasts/broadcasts which indicate the distance of NES cells from the anchor cell 9 based on a timing advance (TA) range. In this case, the UE 3 can compare its current TA range with respect to the anchor cell 9 and the NES cells TA range with respect to the anchor cell 9 to determine if it is within the TA range of one or more NES cells, and hence decide that these NES cells are (or are not) potential candidates to be measured by the UE 3. Conversely, and as is illustrated in FIG. 6, should the UE 3 determine that its TA is outside of the range of a base station operating in a NES state (i.e. the TA range of cell 9A operated by base station 5A, which is shown emboldened) then the UE 3 may rule out such a NES cell as a candidate for measurement.

### Proposal 1b

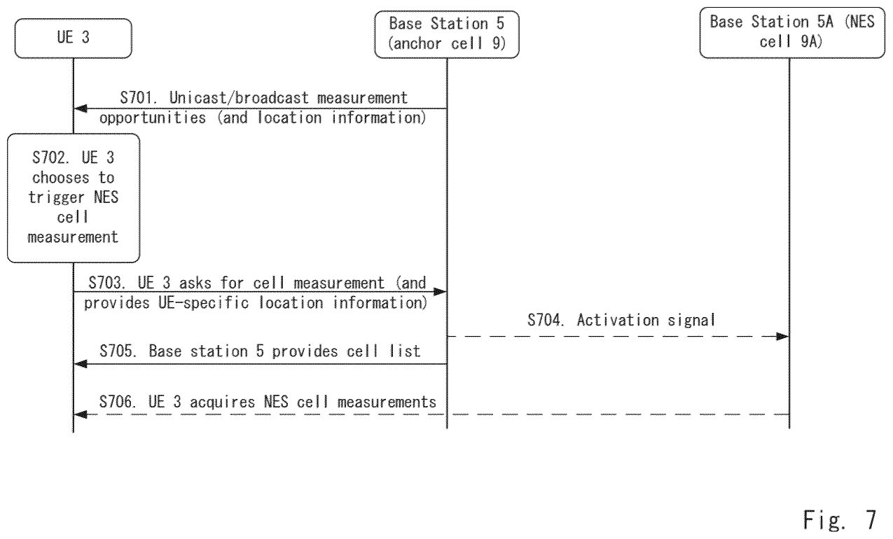

In proposal 1a, the anchor cell provided information with respect to the measurement opportunities (and optionally location information) in respect of non-dormant NES cells, and hence the UE could choose to measure these non-dormant NES cells. However, given that many NES cells may not be suitable for a UE to access, proposal 1b, described below with reference to FIG. 7, sets out a procedure whereby an anchor cell helps the UE to identify potentially suitable NES cells with finer granularity than proposal 1a. Moreover, there may be instances where it could be important for a UE to be able to measure a NES cell which is in a dormant state, for instance, in a case where the UE receives limited information relating to measurable NES cells/where it would be more appropriate that the UE accesses a cell that is in a dormant state. Proposal 1b also sets out a procedure to address this issue.

Specifically, referring to FIG. 7, in S701, anchor cell 9 is configured for unicasting or broadcasting measurement opportunities (and optionally location information) in respect of one or more NES cells which may be suitable for UE 3 to measure in an analogous manner to S501 of FIG. 5, which will not be repeated here, except that in S701 the information also includes information relating any potentially suitable NES cells that are operating in a dormant state.

The UE 3 may then decide, in S702, whether or not to trigger NES cell measurements based on the information received from the anchor cell in S701. If the UE 3 does wish to make cell measurements the UE 3 is configured to send, in S703, a specific cell measurement request which indicates the NES cells it wishes to measure based on the information received in S701. Optionally, the UE may include UE-specific location information in the specific cell measurement request that is provided to the anchor cell when the UE 3 has an RRC connection with the anchor cell 9 (thereby ameliorating security concerns by only signalling the UE 3's location information to the base station 5 to which it is already connected).

By providing this UE-specific location information, the base station 5 operating anchor cell 9 is able to provide a cell list having a much finer granularity to the UE 3, by ruling out cells which are not suitable for the UE 3 based on the UE 3's location relative to other NES cells. Moreover, with this UE location information, the anchor cell 9 is less likely to activate a dormant NES cell which may not be suitable for the UE 3 given its location in the network relative to the dormant NES cell, and hence this proposal beneficially reduces the overall signalling and processing overheads in the network, hence providing potentially significant network energy savings.

Moreover, if the UE 3 indicates as a part of its request in S703 that it wishes to measure a NES cell operating in the dormant state to the anchor cell 9, the anchor cell 9 sends an activation signal, in S704, to those cells (e.g. via the Xn interface or via another appropriate interface). Optionally, the activation signal may also be sent to NES cells operating in the non-dormant state. This activation signal configures one or more NES cells to activate and broadcast synchronization signals using the time and frequency resources which correspond to the signals indicated to the UE 3 as measurement opportunities for those dormant NES cells in S701.

Then, in S705 the base station 5 operating the anchor cell 9A determines which cells the UE has asked to measure are in fact suitable for the UE 3 to measure, e.g. based on the UE's location (e.g. NES cells out of range of the UE 3 could simply be excluded from the list/access capabilities/the likelihood of being able to wake-up a NES cell), and includes these cells in a cell list which is sent to the UE 3. The cell list could be limited in size (e.g. to an arbitrary number of NES cells), and may be rank ordered (e.g. rank ordered based on the likelihood that the NES cell will wake-up, the last time the NES cell was woken, the amount of energy required to wake the cell up, etc.). Moreover, if UE 3 is connected to the anchor cell 9, the anchor cell 9 may make use of information it already has stored in its UE context for UE 3 when making its determination, e.g. its timing advance, beam profile, other core network information (e.g. from a location management function, LMF, etc.). The list may also include any of the aforementioned dormant NES cells, which are now activated and are broadcasting synchronization signals, which UE 3 can measure in S706.

In a deployed network, it will be appreciated that there may be many NES cells which operate within the coverage area of a given anchor cell. To minimize the above-described signalling performed by such anchor cells, anchor cells may be configured to restrict “on-demand” requests (e.g. the request made by the UE in S703), and/or to allocate on-demand resources for broadcasting NES cells information, and/or to allocate on-demand resources for unicasting NES cells information.

### Proposal 2a

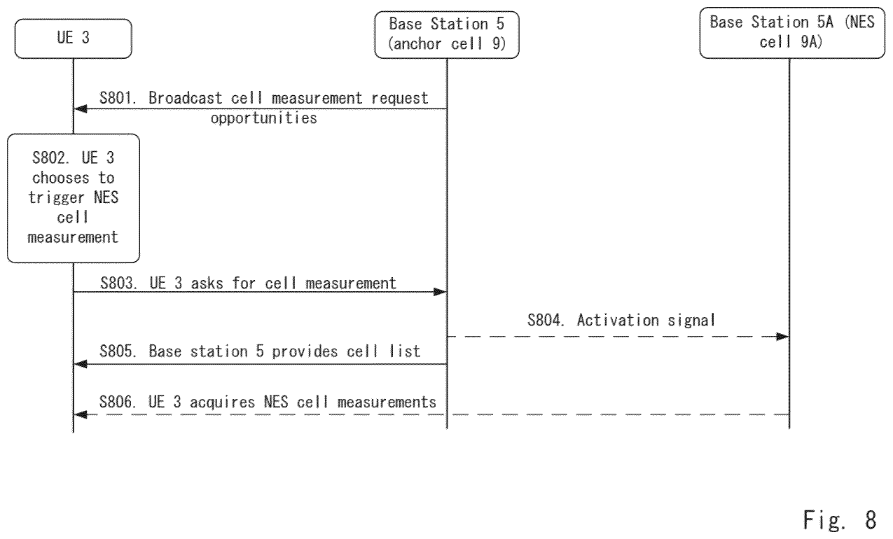

As detailed above, both of proposals 1a and 1b relate to procedures performed by a base station to assist UEs in measuring NES cells during cell (re)selection. Instead, the procedure may be led by the UE, and in this regard, reference will now be made to FIG. 8.

In this example, in step S801 the anchor cell broadcasts cell measurement request opportunities, e.g. opportunities for when the UE 3 may request measurement opportunities of NES cells (i.e. time and frequency information indicating when and where (in the frequency domain) the NES cells will transmit their synchronization signals). Based the received information, the UE 3 may then choose to trigger, in S802, NES cell measurement. If the UE 3 does trigger NES cell measurement, the UE 3 is configured to send, in S803, a specific request to the anchor cell 9 asking for a list of cells which are suitable for measurement (optionally, if the UE 3 is connected to the anchor cell 9, the anchor cell 9 may make use of information it already has stored in its UE context for UE 3 when making its determination, e.g. the UE's timing advance, beam profile, other core network information (e.g. from a location management function, LMF), etc.). If the anchor cell determines that a NES cell suitable for measurement by UE 3 is in a dormant NES state, the anchor cell 9 signals, in S804, to those cells (e.g. via the Xn interface or via another appropriate interface). Optionally, the activation signal may also be sent to NES cells operating in the non-dormant state. This activation signal configures one or more NES cells to activate and broadcast synchronization signals using the time and frequency resources which correspond to the signals indicated to the UE 3 as measurement opportunities for those dormant NES cells in S801.

Then, in S805, a message is sent to the UE 3 comprising a list of cells for the UE 3 to measure in S806. The list may also include any of the aforementioned dormant NES cells, which are now activated, per S804, and are broadcasting synchronization signals which UE 3 can measure in S806.

### Proposal 2b

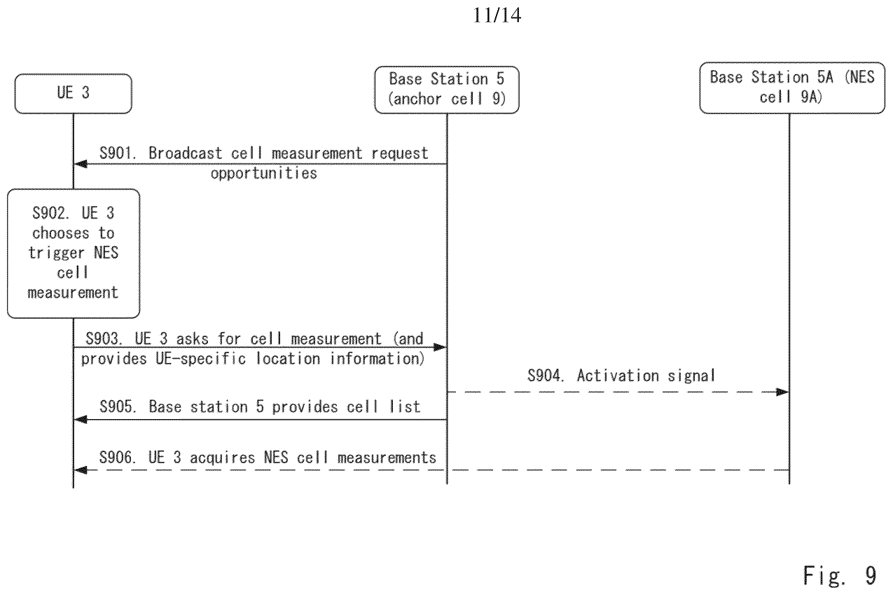

Proposal 2b is an alternative to proposal 2a, in which the UE 3 is connected to the anchor cell which is broadcasting the cell measurement request opportunities (i.e. UE 3 has an RRC connection with base station 5). This example broadly corresponds to steps performed in proposal 2a (which will not be repeated here), except that S903 is modified (as shown in FIG. 9), to include UE-specific location information that is provided to the anchor cell with which UE 3 has an RRC connection (thereby ameliorating security concerns by only signalling the UE 3's location information to the base station 5 to which it is already connected).

By providing this UE-specific location information, the base station 5 operating anchor cell 9 is able to provide a cell list having a much finer granularity to the UE 3, by ruling out cells which are not suitable for the UE 3 based on the UE 3's location relative to other NES cells. Moreover, with this UE location information, the anchor cell 9 is less likely to activate a dormant NES cell which may not be suitable for the UE 3 given its location in the network relative to the dormant NES cell, and hence this proposal beneficially reduces the overall signalling and processing overheads in the network, hence providing potentially significant network energy savings.

### Proposals 3 and 4

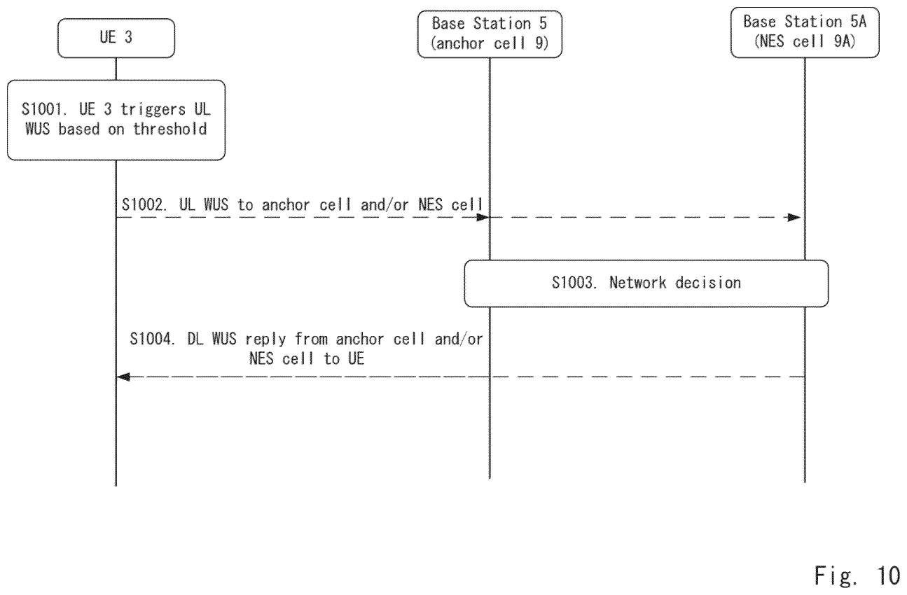

Once the UE 3 has measured one or more NES cells in accordance with the examples described above, or if the UE successfully measured a NES cell during its cell (re)selection procedure, a mechanism is needed by which the UE is be able to make a determination if any NES cells need to be woken up from their dormant state and, if so, to signal to one or more targeted cells that it wishes one or more NES cells to “wake up” (e.g. to request a transition of one or more NES cells from a dormant or reduced transmission/reception activity to a state of active transmission or reception of a channel/signal). In this regard, reference is made to FIG. 10 which illustrates a procedure performed by a UE involving the transmission of a wake-up signal (WUS). It will be appreciated that as this signal is being transmitted from a UE to a base station, this signal may also be referred to as an uplink, UL, WUS.

A WUS may be transmitted from the UE 3 to the base station 5/5A to trigger or request, for example, the transmission of SSB, SIB1 and/or reference signals by a base station 5A. As will be described in more detail below, the WUS does not need to be sent to a specific cell, but may instead be sent to multiple cells including the anchor cell and/or one or more NES cells (if the WUS is sent to the base station 5, base station 5 will forward the WUS to base station 5A via an appropriate interface (e.g. the Xn interface)).

In normal cell (re)selection, the UE typically decides which cell to (re) select based on which cell has a received signal strength/quality that is above a threshold. A similar process is used here to decide which cells that are to be woken up. However, to limit the NES cells that are woken up in this way, a different (e.g. higher) threshold to the normal cell (re)selection threshold is used to trigger transmission of the WUS, so that a NES cell is only woken up if the received signal strength/quality is greater than the higher threshold. Alternatively, a lower threshold may be used as to trigger a WUS in the case where, for example, the UE has a quality of service requirement which can only be met by a NES cell rather than an anchor cell (e.g. in the case where the UE requires a fifth generation service only provided by the NES cell which has a lower RSRP than an anchor cell which is operated by a fourth generation base station (eNB), and hence cannot provide the UE with the desired service).

Once the UE 3 has decided to transmit an UL WUS in S1001, the UE 3 may transmit its UL WUS in S1002 directly to the NES cell 9A (or to as many NES cells deemed suitable by the UE 3 upon triggering in S1001) and/or to the anchor cell 9.

The format of the UL WUS message transmitted by UE 3 may take a simple form or a more complex form. In the simple case, the UL WUS message may take the form of a simple reference signal interpreted by the receiving base station as the binary presence of a UE. For further simplicity, no reply from the network (e.g. the base station 5 operating anchor cell 9 or the base station 5A operating NES cell 9A) is necessary, and UE 3 waits for the NES cell to wake up and update its System Information (SI) and start broadcasting. Alternatively, the network (e.g. the base station 5 operating anchor cell 9 or the base station 5A operating NES cell 9A) could broadcast an acknowledgement reply message which the UE 3 is configured to interpret as a successful wake up of one or more requested NES cells earlier in the procedure, along with an optional indication of when the NES cell SI is due to be updated.

The more complex form of the UL WUS message may be used when the UE 3 is not connected to an anchor cell 9 (and hence the UE 3 may use a random access channel, RACH, procedure with the anchor cell 9 as part of the wake up process).

The UL WUS message in this example may comprise a report of the UE's NES radio quality and/or indicate a quality of service (QoS) that the UE 3 is desirous of, to assist the network to determine which one or more NES cells ought to be awoken for the UE 3. Moreover, the UL WUS may also comprise a rank-ordered list of NES cells which the UE 3 determines are suitable, again to assist the network to determine which one or more NES cells ought to be awoken for the UE 3.

Once the network has taken a decision in S1003 as to which one or more NES cells ought to be awoken for the UE 3, the network proceeds to signal one or more selected NES cells informing them to awake from their NES state. This “network decision” may be taken at the base station 5, at the base station 5A, and/or taken in combination with a node in the core network 7.

Then, in step S1004, the network provides its decision in a reply message that is transmitted to the UE 3 via the anchor cell 9, or via the NES cell 9A, the reply taking one of the following configurations described with reference to proposal 5 below.

### Proposal 5

Proposals 3 and 4 respectively relate to procedures and behaviours at the UE during the WU process. Proposal 5 relates to the network's behaviour during the WU process, particularly to the configuration of the reply message sent by base station 5 or base station 5A in S1004 of FIG. 10. The reply message may take one of the following forms:
A broadcast acknowledgement reply message which indicates the result of the WUS attempt. If the message indicates that the attempt was successful, UE 3 uses the updated NES cell System Information (SI) to access the cell. Optionally, the reply message may include an indication of next NES SI update. If the WUS attempt was not successful (e.g. in a case where the NES cell refuses to be awoken), the reply from base station 5A configures UE 3 to consider that the NES cell is unsuitable for a predefined period (e.g. the NES cell which did not wakeup is treated as cell barred), though it will be appreciated that the UE 3 may still monitor the NES cell in case its SI is updated later; Instead, if the reply message is sent by base station 5, then the reply message comprises information indicating which NES cell 9A which did not wakeup, and configures UE 3 to consider that the NES cell is unsuitable for a predefined period (e.g. the NES cell which did not wakeup is treated as cell barred), though it will be appreciated that the UE 3 may still monitor the NES cell in case its SI is updated later;
A DL reply message (e.g. a broadcast message) that contains the updated NES cell SI (or which indicates that the desired NES cell did not wakeup). On receipt, the UE 3 waits and acquires updated NES cell SI at the DL resource indicated in the DL message. In the case where the UE is not connected to an anchor cell, and the UE 3 uses a RACH procedure to transmit the complex UL WUS message described above, the DL reply message may be a dedicated reply message (instead of a broadcast message). This dedicated reply message acknowledges the UE's WUS message and provides an indication of the NES cell's next NES SI update, or provides the updated NES cell configuration to the UE; and
Instead, no reply may be sent by the network, and the UE 3 therefore assumes that WUS was received and waits for the next NES cell SI to update.

### User Equipment

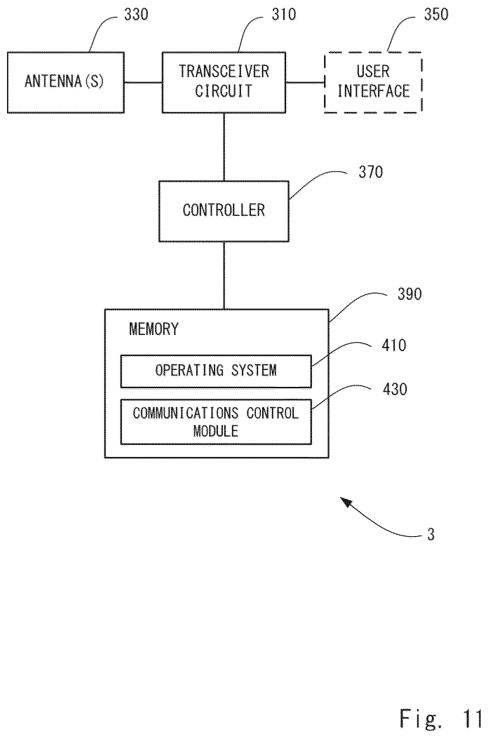

FIG. 11 is a schematic block diagram illustrating the main components of a UE 3 as shown in FIG. 1.

As shown, the UE 3 has a transceiver circuit 310 that is operable to transmit signals to and to receive signals from a base station 5 via one or more antennas 330 (e.g., comprising one or more antenna elements). The UE 3 has a controller 370 to control the operation of the UE 3. The controller 370 is associated with a memory 390 and is coupled to the transceiver circuit 310. Although not necessarily required for its operation, the UE 3 might, of course, have all the usual functionality of a conventional UE 3 (e.g. a user interface 350, such as a touch screen/keypad/microphone/speaker and/or the like for, allowing direct control by and interaction with a user) and this may be provided by any one or any combination of hardware, software, and firmware, as appropriate. Software may be pre-installed in the memory 390 and/or may be downloaded via the telecommunications network or from a removable data storage device (RMD), for example.

The controller 370 is configured to control overall operation of the UE 3 by, in this example, program instructions or software instructions stored within memory 390. As shown, these software instructions include, among other things, an operating system 410, and a communications control module 430.

The communications control module 430 is operable to control the communication between the UE 3 and its serving one or more base stations 5 (and other communication devices connected to the base station 5, such as further UEs and/or core network nodes). The communications control module 430 is configured for the overall handling uplink communications via associated uplink channels (e.g. via a physical uplink control channel (PUCCH), random access channel (RACH), and/or a physical uplink shared channel (PUSCH)) including both dynamic and semi-static signalling (e.g., SRS). The communications control module 430 is also configured for the overall handling of receipt of downlink communications via associated downlink channels (e.g. via a physical downlink control channel (PDCCH) and/or a physical downlink shared channel (PDSCH)) including both dynamic and semi-static signalling (e.g., CSI-RS). The communications control module 430 is responsible, for example: for determining where to monitor for downlink control information (e.g., the location of CSSs/USSs, CORESETs, and associated PDCCH candidates to monitor); for determining the resources to be used by the UE 3 for transmission/reception of UL/DL communications (including interleaved resources and resources subject to frequency hopping); for managing frequency hopping at the UE side; for determining how slots/symbols are configured (e.g., for UL, DL or SBFD communication, or the like); for determining which one or more bandwidth parts are configured for the UE 3; for determining how uplink transmissions should be encoded; for applying any SBFD specific communication configurations appropriately; and the like. The communications control module 430 may be configured to control communications in accordance with any of the methods described above (for example, to transmit an uplink WUS according to any of the methods described above).

### Base Station

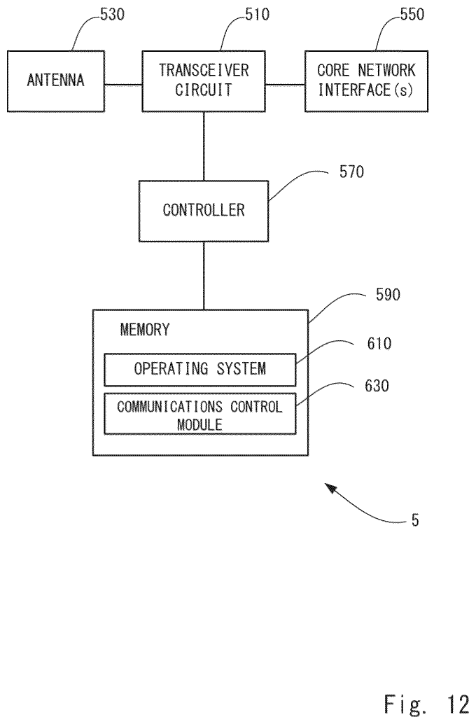

FIG. 12 is a schematic block diagram illustrating the main components of the base station 5 for the communication system 1 shown in FIG. 1. As shown, the base station 5 has a transceiver circuit 510 for transmitting signals to and for receiving signals from the communication devices (such as UEs 3) via one or more antennas 530 (e.g. a single or multi-panel antenna array/massive antenna), and a core network interface 550 (e.g. comprising the N2, N3 and other reference points/interfaces) for transmitting signals to and for receiving signals from network nodes in the core network 7. Although not shown, the base station 5 may also be coupled to other base stations via an appropriate interface (e.g. the so-called ‘Xn’ interface in NR). The base station 5 has a controller 570 to control the operation of the base station 5. The controller 570 is associated with a memory 590. Software may be pre-installed in the memory 590 and/or may be downloaded via the communication system 1 or from a removable data storage device (RMD), for example. The controller 570 is configured to control the overall operation of the base station 5 by, in this example, program instructions or software instructions stored within memory 590.

As shown, these software instructions include, among other things, an operating system 610 and a communications control module 630.

The communications control module 630 is operable to control the communication between the base station 5 and UEs 3 and other network entities that are connected to the base station 5. The communications control module 630 is configured for the overall control of the reception and decoding of uplink communications, via associated uplink channels (e.g. via a physical uplink control channel (PUCCH), a random-access channel (RACH), and/or a physical uplink shared channel (PUSCH)) including both dynamic and semi-static signalling (e.g., SRS). The communications control module 630 is also configured for the overall handling the transmission of downlink communications via associated downlink channels (e.g. via a physical downlink control channel (PDCCH) and/or a physical downlink shared channel (PDSCH)) including both dynamic and semi-static signalling (e.g., CSI-RS). The communications control module 630 is responsible for managing full duplex (e.g., SBFD) communication including, where appropriate, the segregation of UL and DL communication via different physical antenna elements. The communications control module 630 is responsible, for example: for determining where to configure the UE 3 to monitor for downlink control information (e.g., the location of CSSs/USSs, CORESETs, and associated PDCCH candidates to monitor); for determining the resources to be scheduled for UE transmission/reception of UL/DL communications (including interleaved resources and resources subject to frequency hopping); for managing frequency hopping at the base station side; for configuring slots/symbols appropriately (e.g., for UL, DL or SBFD communication, or the like); for configuring one or more bandwidth parts for the UE 3; for providing related configuration signalling to the UE 3; and the like. The communications control module 630 may be configured to control communications in accordance with any of the methods described above (for example, to receive an uplink WUS and perform corresponding transmission and/or reception of signals to/from the UE 5 as described above).

### Modifications and Alternatives

As those skilled in the art will appreciate, a number of modifications and alternatives can be made to the above example embodiments whilst still benefiting from the disclosures embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied as a signal over a computer network, or on a recording medium. Further, the functionality performed by part, or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.). A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine type communication applications.

| Service Area | MTC applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch exchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary example embodiments described in the present document. Needless to say, these technical ideas and example embodiments are not limited to the above-described UE and various modifications can be made thereto.

Various other modifications will be apparent to those skilled in the art and will not be described in further detail here.

For example, the whole or part of the exemplary embodiments disclosed above can be described as, but not limited to, the following supplementary notes.

### (Supplementary Note 1)

A method for a user equipment, UE, in a telecommunication system comprising a first access network node operating a first cell and at least one second access network node operating at least one network energy saving, NES, cell, the method comprising:
receiving, from the first access network node, information relating to measurement opportunities for the at least one NES cell; and measuring signals transmitted by the at least one NES cell based on the received information.

### (Supplementary Note 2)

The method of supplementary note 1, wherein the information comprises location information in respect of the at least one NES cell and wherein the UE decides whether or not to trigger a measurement of the at least one NES cell using the location information.

### (Supplementary Note 3)

The method of supplementary note 2, wherein the UE decides whether or not to trigger a measurement of the at least one NES cell using the location information and location information for the UE.

### (Supplementary Note 4)

The method of supplementary note 2 or supplementary note 3, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 5)

A method for an access network node operating a first cell in a telecommunication system, the telecommunication system further comprising a user equipment, UE, and at least one second access network node operating at least one network energy saving, NES, cell, the method comprising:
transmitting, to the UE, a message comprising information relating to measurement opportunities for the at least one NES cell, to allow the UE to measure signals transmitted by the at least one second cell.

### (Supplementary Note 6)

The method of supplementary note 5, wherein the information comprises location information in respect of the at least one NES cell to allow the UE to decide whether or not to trigger a measurement of the at least one NES cell using the location information.

### (Supplementary Note 7)

The method of supplementary note 5 or supplementary note 6, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 8)

A user equipment, UE, in a telecommunication system comprising a first access network node operating a first cell and at least one second access network node operating at least one network energy saving, NES, cell, the UE comprising:
means for receiving, from the first access network node, information relating to measurement opportunities for the at least one NES cell; and
means for measuring signals transmitted by the at least one NES cell based on the received information.

### (Supplementary Note 9)

The UE of supplementary note 8, wherein the information comprises location information in respect of the at least one NES cell and wherein the UE is configured to decide whether or not to trigger a measurement of the at least one NES cell using the location information.

### (Supplementary Note 10)

The UE of supplementary note 9, wherein the UE is configured to decide whether or not to trigger a measurement of the at least one NES cell using the location information and location information for the UE.

### (Supplementary Note 11)

The UE of supplementary note 9 or supplementary note 10, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 12)

An access network node configured to operate a first cell in a telecommunication system, the telecommunication system further comprising a user equipment, UE, and at least one second access network node operating at least one network energy saving, NES, cell, the access network node comprising:
means for transmitting, to the UE, a message comprising information relating to measurement opportunities for the at least one NES cell, to allow the UE to measure signals transmitted by the at least one second cell.

### (Supplementary Note 13)

The access network node of supplementary note 12, wherein the information comprises location information in respect of the at least one NES cell to allow the UE to decide whether or not to trigger a measurement of the at least one NES cell using the location information.

### (Supplementary Note 14)

The access network node of supplementary note 12 or supplementary note 13, wherein the location information comprises one or more of:

coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 15)

A method for a user equipment, UE, in a telecommunication system comprising a first access network node operating a first cell and a plurality of second access network nodes operating respective network energy saving, NES, cells, the method comprising:
receiving, from the first access network node, information indicating measurement opportunities for the plurality of NES cells;
transmitting, to the first access network node, a list of NES cells for the UE to measure;
receiving, from the first access network node, a cell list comprising at least one NES cell of the plurality of NES cells for the UE to measure; and
acquiring measurements of the at least one NES cell based on the received cell list and a measurement opportunity indicated by the information, for the at least one NES cell.

### (Supplementary Note 16)

The method according to supplementary note 15, wherein the transmitting to the first access network node further comprises transmitting UE-specific location information.

### (Supplementary Note 17)

The method according to supplementary note 16, wherein the UE-specific location information is only provided in a case where the UE is connected to the first cell.

### (Supplementary Note 18)

The method of any one of supplementary note 15 to 17, wherein the information comprises location information in respect of the plurality of NES cells to allow the UE to decide which NES cells to include in the list of NES cells the UE transmits to the first access network node.

### (Supplementary Note 19)

The method of supplementary note 18, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 20)

A method for a first access network node operating a first cell in a telecommunication system, the telecommunication system further comprising a user equipment, UE, and a plurality of second access network nodes operating a respective network energy saving, NES, cell, the method comprising:
transmitting, to the UE, information indicating measurement opportunities for the plurality of NES cells;
receiving, from the UE, a list of NES cells for the UE to measure; and
transmitting, to the UE, a cell list comprising at least one NES cell of the plurality of NES cells for the UE to measure.

### (Supplementary Note 21)

The method according to supplementary note 20, wherein the receiving from the UE further comprises receiving UE-specific location information.

### (Supplementary Note 22)

The method according to supplementary note 21, wherein the UE-specific location information is only provided in a case where the UE is connected to the first cell.

### (Supplementary Note 23)

The method of any one of supplementary notes 20 to 22 further comprising, in a case where the cell list includes a dormant NES cell operating in a dormant energy saving state, transmitting an activation signal to the dormant NES cell to cause the dormant NES cell to activate and broadcast synchronization signals to allow the UE to measure the dormant NES cell.

### (Supplementary Note 24)

The method according to supplementary note 23, wherein the activation signal identifies resources to be used by the dormant NES cell to transmit its synchronization signals corresponding to the measurement opportunities indicated to the UE in the information for that dormant NES cell.

### (Supplementary Note 25)

The method of any one of supplementary notes 20 to 24, wherein the information comprises location information in respect of the NES cells to allow the UE to decide which NES cells to include in the list of NES cells the UE transmits to the first access network node.

### (Supplementary Note 26)

The method of supplementary note 25, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 27)

A method for a second access network node operating a network energy saving, NES, cell in a dormant state, the telecommunication system further comprising a user equipment, UE, and a first access network node operating a first cell, the method comprising:
receiving, from the first access network node, an activation signal causing the dormant NES cell to activate and broadcast synchronization signals to allow the UE to measure the dormant NES cell.

### (Supplementary Note 28)

The method according to supplementary note 27, wherein the activation signal identifies resources to be used by the dormant NES cell to transmit its synchronization signals.

### (Supplementary Note 29)

A user equipment, UE, in a telecommunication system comprising a first access network node operating a first cell and a plurality of second access network nodes operating respective network energy saving, NES, cells, the UE comprising:
means for receiving, from the first access network node, information indicating measurement opportunities for the plurality of NES cells;
means for transmitting, to the first access network node, a list of NES cells for the UE to measure;
means for receiving, from the first access network node, a cell list comprising at least one NES cell of the plurality of NES cells for the UE to measure; and
means for acquiring measurements of the at least one NES cell based on the received cell list and a measurement opportunity indicated by the information, for the at least one NES cell.

### (Supplementary Note 30)

The UE according to supplementary note 29, wherein the transmission to the first access network node further comprises UE-specific location information.

### (Supplementary Note 31)

The UE according to supplementary note 30, wherein the UE-specific location information is only provided in a case where the UE is connected to the first cell.

### (Supplementary Note 32)

The UE of supplementary note any one of supplementary notes 29 to 31, wherein the information comprises location information in respect of the plurality of NES cells to allow the UE to decide which NES cells to include in the list of NES cells the UE transmits to the first access network node.

### (Supplementary Note 33)

The UE of supplementary note 32, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 34)

A first access network node configured to operate a first cell in a telecommunication system, the telecommunication system further comprising a user equipment, UE, and a plurality of second access network nodes operating a respective network energy saving, NES, cell, the first access node comprising:
means for transmitting, to the UE, information indicating measurement opportunities for the plurality of NES cells;
means for receiving, from the UE, a list of NES cells for the UE to measure; and
means for transmitting, to the UE, a cell list comprising at least one NES cell of the plurality of NES cells for the UE to measure.

### (Supplementary Note 35)

The first access node according to supplementary note 34, wherein the receiving from the UE further comprises receiving UE-specific location information.

### (Supplementary Note 36)

The first access node according to supplementary note 35, wherein the UE-specific location information is only provided in a case where the UE is connected to the first cell.

### (Supplementary Note 37)

The first access network node of any one of supplementary notes 34 to 36 further comprising, in a case where the cell list includes a dormant NES cell operating in a dormant energy saving state, means for transmitting an activation signal to the dormant NES cell to cause the dormant NES cell to activate and broadcast synchronization signals to allow the UE to measure the dormant NES cell.

### (Supplementary Note 38)

The first access node according to supplementary note 37, wherein the activation signal identifies resources to be used by the dormant NES cell to transmit its synchronization signals corresponding to the measurement opportunities indicated to the UE in the information for that dormant NES cell.

### (Supplementary Note 39)

The first access node of any one of supplementary notes 34 to 38, wherein the information comprises location information in respect of the NES cells to allow the UE to decide which NES cells to include in the list of NES cells the UE transmits to the first access network node.

### (Supplementary Note 40)

The first access node of supplementary note 39, wherein the location information comprises one or more of: coordinates of the at least one NES cell, beam profile information of the at least one NES cell having the same beam profile as the UE, beam strength information, the physical distance of the UE from the first cell, and the physical distance of the UE from the at least one NES cell.

### (Supplementary Note 41)

A second access network node configured to operate a network energy saving, NES, cell in a dormant state, the telecommunication system further comprising a user equipment, UE, and a first access network node operating a first cell, the second access node comprising: means for receiving, from the first access network node, an activation signal causing the dormant NES cell to activate and broadcast synchronization signals to allow the UE to measure the dormant NES cell.

### (Supplementary Note 42)

The second access network node according to supplementary note 41, wherein the activation signal identifies resources to be used by the dormant NES cell to transmit its synchronization signals.

### (Supplementary Note 43)

A method for a user equipment, UE, in a telecommunication system comprising a first access network node operating a first cell and a plurality of second access network nodes respectively operating network energy saving, NES, cells, the method comprising:
transmitting, to the first access network node, a request for cell measurement information of NES cells;
receiving a cell list, from the first access network node, comprising information indicating measurement opportunities for at least one NES cell for the UE to measure; and
acquiring measurements of the at least one NES cell based on the received information.

### (Supplementary Note 44)

The method according to supplementary note 43, wherein the request for cell measurements further comprises UE-specific location information.

### (Supplementary Note 45)

The method according to supplementary note 44, wherein the UE-specific location information is only provided in a case where the UE is connected to the first cell.

### (Supplementary Note 46)

A method for a first access network node operating a first cell in a telecommunication system, the telecommunication system further comprising a user equipment, UE, and a plurality of second access network nodes operating respective network energy saving, NES, cells, the method comprising:
receiving, from the UE, a request for cell measurement information of NES cells;
determining a cell list comprising measurement opportunity information for at least one suitable NES cell for the UE to measure; and
transmitting, to the UE, the cell list.

### (Supplementary Note 47)

The method according to supplementary note 46, wherein the request for cell measurement information further comprises UE-specific location information in a case where the UE is connected to the first cell.

### (Supplementary Note 48)

The method according to supplementary note 46 or supplementary note 47 further comprising, in the case where the UE requests measurement of a second cell operating in a dormant energy saving state, transmitting an activation signal to the dormant NES cell to cause the dormant NES cell to activate and broadcast synchronization signals to allow the UE to measure the dormant NES cell.

### (Supplementary Note 49)

The method according to supplementary note 48, wherein the activation signal identifies resources to be used by the dormant NES cell to transmit its synchronization signals corresponding to the measurement opportunities of the dormant NES cell indicated to the UE in cell list.

### (Supplementary Note 50)

A user equipment, UE, in a telecommunication system comprising a first access network node operating a first cell and a plurality of second access network nodes respectively operating network energy saving, NES, cells, the UE comprising:
means for transmitting, to the first access network node, a request for cell measurement information of NES cells;
means for receiving a cell list, from the first access network node, comprising information indicating measurement opportunities for at least one NES cell for the UE to measure; and
means for acquiring measurements of the at least one NES cell based on the received information.

### (Supplementary Note 51)

The UE according to supplementary note 50, wherein the request for cell measurements further comprises UE-specific location information.

### (Supplementary Note 52)

The UE according to supplementary note 51, wherein the UE-specific location information is only provided in a case where the UE is connected to the first cell.

### (Supplementary Note 53)

A first access network node configured to operate a first cell in a telecommunication system, the telecommunication system further comprising a user equipment, UE, and a plurality of second access network nodes operating respective network energy saving, NES, cells, the first access node comprising:
means for receiving, from the UE, a request for cell measurement information of NES cells;
means for determining a cell list comprising measurement opportunity information for at least one suitable NES cell for the UE to measure; and
means for transmitting, to the UE, the cell list.

### (Supplementary Note 54)

The first access network node according to supplementary note 53, wherein the request for cell measurement information further comprises UE-specific location information in a case where the UE is connected to the first cell.

### (Supplementary Note 55)

The first access network node according to supplementary note 53 or supplementary note 54 further comprising, in the case where the UE requests measurement of a second cell operating in a dormant energy saving state, means for transmitting an activation signal to the dormant NES cell to cause the dormant NES cell to activate and broadcast synchronization signals to allow the UE to measure the dormant NES cell.

### (Supplementary Note 56)

The first access network node according to supplementary note 55, wherein the activation signal identifies resources to be used by the dormant NES cell to transmit its synchronization signals corresponding to the measurement opportunities of the dormant NES cell indicated to the UE in cell list.

### (Supplementary Note 57)

A method performed by a user equipment, UE, in a telecommunication system, the telecommunication system further comprising a first access network node operating a first cell and at least one second access network node operating a network energy saving, NES, cell, the method comprising:
triggering transmission of a wakeup signal, WUS, to the first access network node and/or to the at least one second access network node in a case where the UE satisfies a WUS trigger threshold.

### (Supplementary Note 58)

The method according to supplementary note 57, wherein:
the WUS comprises a reference signal which configures the receiving first access network node and/or second access network node to interpret the presence of the UE, or;
wherein the WUS comprises at least one of: information relating to UE's radio quality relative to at least one NES cell, the UE's desired quality of service, a cause value, or an ordered list of suitable NES cells.

### (Supplementary Note 59)

The method according to supplementary note 58, further comprising receiving a reply from the first cell and/or the NES cell and in a case where the reply indicates that the WUS was successful, using updated system information of the at least one NES cell to access the at least one NES cell.

### (Supplementary Note 60)

The method according to supplementary note 59, further comprising receiving a reply from the first cell and/or the NES cell and in a case where the reply originates from the first access network node and indicates that the WUS was not successful, the reply message comprises information indicating the at least one NES cell which did not wakeup and which configures the UE for treating the at least one NES cell as unsuitable for measurement for a period of time.

### (Supplementary Note 61)

The method according to supplementary note 59, further comprising receiving a reply from the first cell and/or the NES cell and in a case where the reply originates from the second access network node and indicates that the WUS was not successful, the reply message comprises information indicating the second cell did not wakeup and which configures the UE for treating the second cell as unsuitable for measurement for a period of time.

### (Supplementary Note 62)

The method according to any one of supplementary notes 59 to 61, wherein the reply message is a broadcast acknowledgement reply message.

### (Supplementary Note 63)

The method according to any one of supplementary notes 59 to 61, wherein the reply message is a dedicated acknowledgement reply message for the UE.

### (Supplementary Note 64)

A user equipment, UE, in a telecommunication system, the telecommunication system further comprising a first access network node operating a first cell and at least one second access network node operating a network energy saving, NES, cell, the UE comprising: means for triggering transmission of a wakeup signal, WUS, to the first access network node and/or to the at least one second access network node in a case where the UE satisfies a WUS trigger threshold.

### (Supplementary Note 65)

The UE according to supplementary note 64, wherein:
the WUS comprises a reference signal which configures the receiving first access network node and/or second access network node to interpret the presence of the UE, or;
wherein the WUS comprises at least one of: information relating to UE's radio quality relative to at least one NES cell, the UE's desired quality of service, a cause value, or an ordered list of suitable NES cells.

### (Supplementary Note 66)

The UE according to supplementary note 65, further comprising means for receiving a reply from the first cell and/or the NES cell and in a case where the reply indicates that the WUS was successful, the UE is configured to use updated system information of the at least one NES cell to access the at least one NES cell;

### (Supplementary Note 67)

The UE according to supplementary note 66, further comprising means for receiving a reply from the first cell and/or the NES cell and in a case where the reply originates from the first access network node and indicates that the WUS was not successful, the reply message comprises information indicating the at least one NES cell which did not wakeup and which configures the UE to treat the at least one NES cell as unsuitable for measurement for a period of time.

### (Supplementary Note 68)

The UE according to supplementary note 66, further comprising means for receiving a reply from the first cell and/or the NES cell and in a case where the reply originates from the second access network node and indicates that the WUS was not successful, the reply message comprising information indicating the second cell did not wakeup and which configures the UE to treat the second cell as unsuitable for measurement for a period of time.

### (Supplementary Note 69)

The UE according to any one of supplementary notes 66 to 68, wherein the reply message is a broadcast acknowledgement reply message.

### (Supplementary Note 70)

The UE according to any one of supplementary notes 66 to 68, wherein the reply message is a dedicated acknowledgement reply message for the UE.

This application is based upon and claims the benefit of priority from Great Britain Patent Application No. 2302235.3, filed on Feb. 16, 2023, the disclosure of which is incorporated herein in its entirety by reference.

### REFERENCE SIGNS LIST

1 COMMUNICATION SYSTEM
3 USER EQUIPMENT
5 BASE STATION
7 CORE NETWORK
9 CELL
10 CONTROL PLANE FUNCTIONS
11 USER PLANE FUNCTIONS
310 TRANSCEIVER CIRCUIT
330 ANTENNA

What is claimed is:

1-30. (canceled)

31. A method for a mobile device, the method comprising:
receiving, from a first access network node, first information relating to measurement opportunities for a network energy saving (NES) cell operated by a second access network node;
performing a measurement of the NES cell based on the first information; and
transmitting a wakeup signal (WUS) to the second access network node based on the measurement of the NES cell.

32. The method according to claim 31, wherein
the transmitting the WUS is performed based on a received signal strength/quality of the NES cell.

33. The method according to claim 31, further comprising:
receiving a response from the NES cell; and
in a case where the response indicates that the WUS was successful, using updated system information of the NES cell to access the NES cell.

34. The method according to claim 31, further comprising: wherein
in a case where the WUS was not successful, treating the NES cell as unsuitable for the measurement for a period of time.

35. The method according to claim 33, wherein
the response includes at least one of:
a broadcast acknowledgement reply message, or
a dedicated acknowledgement reply message for the mobile device.

36. The method according to claim 31, wherein
the transmitting the WUS is performed using a random access channel (RACH) procedure.

37. A method for an access network node, the method comprising:
transmitting, to a mobile device, first information relating to measurement opportunities for a network energy saving (NES) cell operated by a second access network node, to allow the mobile device to perform a measurement of the NES cell, and wherein
a wakeup signal (WUS) is transmitted from the mobile device to the second access network node based on the measurement of the NES cell.

38. A mobile device comprising:
a memory configured to store instructions; and
a processor configured to execute the instructions to:
receive, from a first access network node, first information relating to measurement opportunities for a network energy saving (NES) cell operated by a second access network node;
perform a measurement of the NES cell based on the first information; and
transmit a wakeup signal (WUS) to the second access network node based on the measurement of the NES cell.

39. An access network node comprising:
a memory configured to store instructions; and
a processor configured to execute the instructions to:
transmit, to a mobile device, first information relating to measurement opportunities for a network energy saving (NES) cell operated by a second access network node, to allow the mobile device to perform a measurement of the NES cell, and wherein
a wakeup signal (WUS) is transmitted from the mobile device to the second access network node based on the measurement of the NES cell.
